(19) United States
(12) Patent Application Publication
(10) Pub. No.: US 2015/0246578 A1
(43) Pub. Date: Sep. 3, 2015

(54) MULTI-PIECE RIM ASSEMBLY

(71) Applicant: Caterpillar Inc., Peoria, IL (US)

(72) Inventors: Adam Louis OFISHER, Elk Grove Village, IL (US); Matthew John HESS, Aurora, IL (US)

(73) Assignee: Caterpillar Inc., Peoria, IL (US)

(21) Appl. No.: 14/193,608

(22) Filed: Feb. 28, 2014

(51) Int. Cl. B60B 25/14; B60B 21/10

(52) U.S. Cl. CPC B60B 25/14; B60B 21/10; B60B 2900/541; B60Y 2200/20; B60B 2320/10

(57) ABSTRACT

Disclosed are various exemplary embodiments of a multi-piece rim assembly for mounting a tire. The rim assembly may include a rim base having a first end and a second end, a flange detachably mountable to the first end of the rim base, and a flange assembly detachably mountable to the second end of the rim base. The flange and the rim base may cooperatively define a first bead seat for receiving a first bead of the tire, and the flange assembly may define a second bead seat for receiving a second bead of the tire. The flange assembly may be formed of a unitary construction that includes a bead seat section having an outer surface for contacting a bottom edge of the second bead of the tire and a flange section extending substantially radially outwardly from the bead seat section to contact a side wall of the second bead of the tire. The rim assembly may also include a lock ring configured to secure the flange assembly to the rim base.

### TECHNICAL FIELD

The present disclosure relates generally to tire rim assemblies for vehicles and, more particularly, to multi-piece rim assemblies for off-highway vehicles.

### BACKGROUND

Off-highway vehicles, such as earthmoving or hauling machines that are designed to be driven on unpaved terrains, use either single- or multi-piece rims for mounting tires primarily depending on the types of applications that the vehicles are intended to perform. In general, single-piece rims are used for light duty applications, and multi-piece rims are used for moderate- to heavy-duty applications. For example, a vehicle intended to be used for light-duty applications uses a relatively small tire with sufficient flexibility at its beads to allow slight deformation to fit over and between side flanges of the rim. Thus, the flexibility of the tire used for light-duty applications permits the rim to be formed of unitary construction, integrating the side flanges with a rim base in a single piece. On the other hand, a vehicle intended to be used for moderate- or heavy-duty applications uses a relatively large tire with structurally reinforced beads that do not allow sufficient deformation to be placed over the side flanges of the rim. As a result, the rims for moderate- to heavy-duty applications are usually formed of multiple pieces to facilitate mounting and demounting the tire.

For moderate- and heavy-duty applications, either three-piece or five-piece rims have been most widely used in the past. In a three-piece rim structure, an example of which is disclosed in U.S. Pat. No. 2,817,383 to Grant, a first retaining flange on the inboard side is integrally formed with a rim base, while a second retaining flange on the outboard side is integrally formed with a bead seat to form a flange assembly. The flange assembly is slidably mounted over the outboard side of the rim base and is secured in place by a lock ring. Three-piece rims are generally considered for moderate-duty applications, and their use is often limited to rims sized 25 inches or less in diameter. This is because, among other reasons, the three-piece structure makes it difficult for service tools to efficiently break the tire bead from the rim on the inboard side of the rim. Further, since the three-piece rim typically uses a lighter duty rim base, the force exerted by the bead breaking tools to break the tire bead from the rim may compromise the structural integrity of the rim due to excessive deflection on the inboard side of the rim.

Five-piece rims are generally considered heavy duty and are used on rims sized greater than 25 inches. An example of a five-piece rim is disclosed in U.S. Pat. No. RE33,046 to Suckow. As shown in the example, a five-piece rim may include a rim base, a bead seat slidably mounted over the outboard side of the rim base, a lock ring for securing the bead seat in the rim base, a first retaining flange detachably mounted to the inboard side of a rim base, and a second retaining flange detachably mounted to the bead seat. The detachability of the retaining flanges from the rim base can facilitate demounting of the tire because it can provide better fitment and leverage of service tools to break the tire bead.

### SUMMARY

The disclosed multi-piece rim assembly is directed at providing improvements over existing rim assembly designs.

According to one exemplary aspect, the present disclosure is directed to a multi-piece rim assembly for mounting a tire. The rim assembly may include a rim base having a first end and a second end, a flange detachably mountable to the first end of the rim base, and a flange assembly detachably mountable to the second end of the rim base. The flange and the rim base may cooperatively define a first bead seat for receiving a first bead of the tire, and the flange assembly may define a second bead seat for receiving a second bead of the tire. The flange assembly may be formed of a unitary construction that includes a bead seat section having an outer surface for contacting a bottom edge of the second bead of the tire and a flange section extending substantially radially outwardly from the bead seat section to contact a side wall of the second bead of the tire. The rim assembly may also include a lock ring configured to secure the flange assembly to the rim base.

Another exemplary aspect of the present disclosure may provide a multi-piece rim assembly for mounting a tire, which include a rim base having a first end and a second end, a flange detachably mountable to the first end of the rim base to restrain a first bead of the tire, and a flange assembly detachably mountable to the second end of the rim base to restrain a second bead of the tire. The rim base may have an outer diameter greater than about 25 inches. The flange assembly may also include a bead seat section having an outer surface for contacting a bottom edge of the second bead of the tire and a flange section integrally formed with and extending radially outwardly from the bead seat section to contact a side wall of the second bead of the tire. The rim assembly may also include a lock ring configured to secure the flange assembly to the rim base.

In still another exemplary aspect, the present disclosure is directed to a method of demounting a tire from a multi-piece rim assembly, where the rim assembly may include a rim base, a flange detachably mountable to a first end of the rim base, and a flange assembly detachably mountable to a second end of the rim base. The method may include inserting a bead breaking tool into a gap between the first end of the rim base and the flange to unseat a first tire bead from the rim base and displacing the flange assembly axially from the second end towards the first tire bead. The flange assembly may be formed of a unitary construction including a bead seat section for contacting a bottom edge of a second bead of the tire and a flange section for contacting a side wall of the second bead of the tire. The method may further include removing a lock ring while the flange assembly is being displaced axially towards the first tire bead, removing the flange assembly in the direction of the second end, and removing the tire from the rim base in the direction of the second end.

### BRIEF DESCRIPTION OF THE DRAWINGS

FIG. 1 is a side view of a multi-piece rim assembly, according to one exemplary embodiment of the present disclosure;

FIG. 2 is a cross-sectional view of the multi-piece rim assembly shown in FIG. 1 along plane II-II; and

FIG. 3 is an exploded view of the top portion of the multi-piece rim assembly shown in FIG. 2.

### DETAILED DESCRIPTION

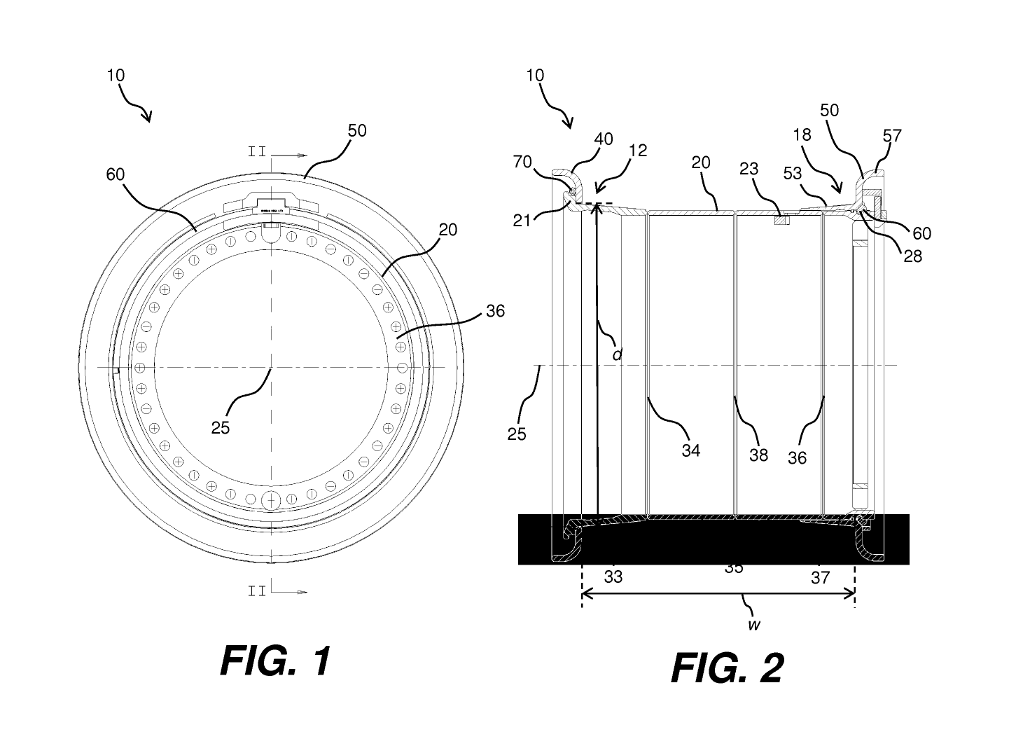

FIGS. 1-3 illustrate an exemplary embodiment of a multi-piece rim assembly for off-highway vehicles. While various embodiments of the present disclosure will be described in connection with off-highway vehicles, it should be understood that the present disclosure may be applied to, or used in connection with, virtually any type of vehicles and/or aircrafts ranging from passenger cars and trucks to military vehicles and aircrafts.

The present disclosure is directed to a unique rim structure that may provide enhanced serviceability and value for vehicles designed to perform heavy-duty applications, in particular for vehicles having rim sizes in the range of about 25 inches to about 33 inches in diameter. More specifically, the exemplary embodiments of the present disclosure incorporate certain features of a five-piece rim structure that promotes easy serviceability on the inboard side of the rim and certain features of a three-piece rim structure that promotes manufacturing efficiency and part simplification without compromising the serviceability on the outboard side of the rim.

Now referring to FIGS. 1 and 2, a multi-piece rim assembly 10 of the present disclosure may include a rim base 20, an inboard flange 40 defining a first bead seat 12 in cooperation with rim base 20, an outboard flange assembly 50 defining a second bead seat 18, and a lock ring 60 configured to retain outboard flange assembly 50 onto rim base 20 under the pressure of an inflated tire. Tire beads (not shown) are wedged and axially restrained between first bead seat 12 and second bead seat 18 in sealing relation.

Rim base 20 may be a substantially cylindrical body having an axial center line 25. In some exemplary embodiments, rim base 20 may be formed of two or more sections joined together via a suitable fastening method, such as welding. For example, as best shown in FIG. 2, rim base 20 may include a substantially cylindrical center section 35, a conical section 33 disposed on the inboard side adjacent to center section 35, and a gutter section 37 disposed on the outboard side adjacent to center section 35. Conical section 33 may be welded to center section 35 via a first welding plate 34, and gutter section 37 may be welded to center section 35 via a second welding plate 36. In the disclosed embodiment of FIG. 2, center section 35 may be composed of two sections welded together via a third welding plate 38. At least one of first, second, and third welding plates 34, 36, and 38 may be configured to engage with a suitable mounting disk for mounting to an axle hub of a vehicle. It should be understood that the disclosed configuration of rim base 20 is merely exemplary and that any other configuration of rim base 20 known in the art can be used alternatively or additionally.

Center section 35 of rim base 20 may also include one or more air openings 23 that allow a suitable air tubing or valve assembly to be installed therewith to inflate or deflate the tire.

The outer diameter of conical section 33 gradually increases towards the inboard side, forming a slightly inclined outer surface. In one exemplary embodiment, the degree of inclination with respect to the outer surface of center section 35 is about 5 degrees. At the outer edge of conical section 33, rim base 20 may form a back flange 21 extending radially away from axial centerline 25. As will be described later, inboard flange 40 may be telescopically positioned adjacent back flange 21 to define first bead seat 12 in cooperation with the inclined outer surface of conical section 33.

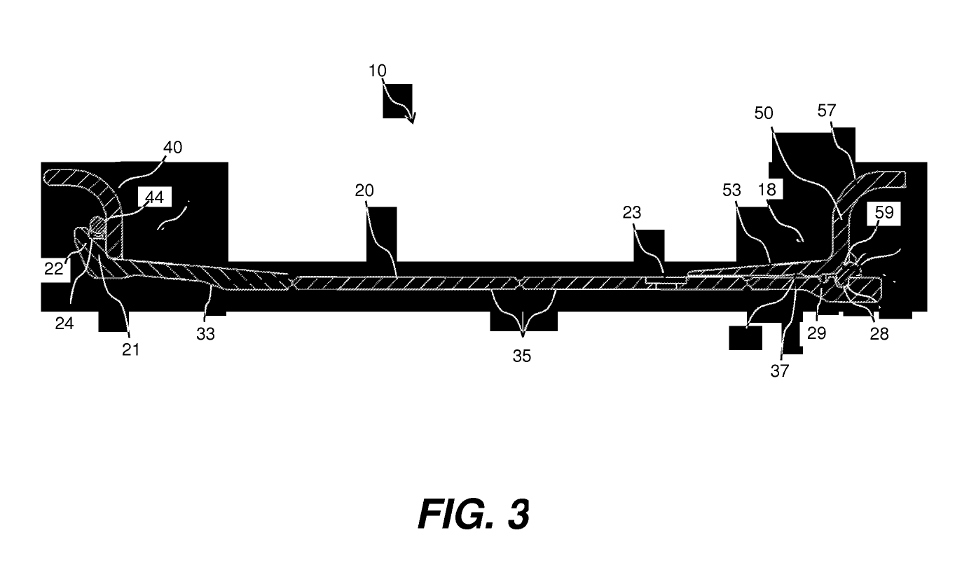

In some exemplary embodiments, inboard flange 40 and rim base 20 may include a suitable interlocking mechanism to prevent relative rotation therebetween during an assembled condition. For example, as best shown in FIG. 3, back flange 21 may include a first locking member 24 projecting from an annular groove 22 towards inboard flange 40, and inboard flange 40 may include a second locking member 44 projecting from an outer surface towards back flange 21 to engage with first locking member 24. First locking member 24 may include a pair of first cylindrical lugs welded to annular groove 22, where the pair defines an annular space therebetween. Second locking member 44 may include a second cylindrical lug welded to the outer surface of inboard flange 40 and having a length slightly shorter than the annular space between the pair of first cylindrical lugs. When inboard flange 40 is inserted over rim base 20, second cylindrical lug is inserted into the annular space between the annular space defined by the pair of second cylindrical lugs to prevent relative rotation between rim base 20 and inboard flange 40. It should be noted that any other design and/or configuration known in the art can be used alternatively or additionally for the above-described interlocking mechanism.

Gutter section 37 of rim base 20 may define a lock ring groove 28 configured to engage with a portion of lock ring 60. Gutter section 37 may also define a sealing groove 29 configured to receive a sealing member, such as an O-ring or elastomeric seal, to seal the space between outboard flange assembly 50 and rim base 20. The edge portion of gutter section 37 that defines at least lock ring groove 28 may have an increased thickness to provide a greater strength so as to maintain structural integrity during mounting and demounting of a tire.

By way of example only, the outer diameter d of rim base 20 as measured from its outermost surfaces, excluding back flange 21, may range from about 25 inches to about 35 inches, as shown in FIG. 2. In some exemplary embodiments, outer diameter d may be about 33 inches.

As mentioned above, inboard flange 40 may be configured to detachably engage with back flange 21 of rim base 20 and, in cooperation with the outer surface of conical section 33 of rim base 20, defines first bead seat 12. Inboard flange 40 may have a generally convex shape, first extending radially outwardly from rim base 20 and then curving radially outwardly towards the inboard side. When a tire is mounted, inboard flange 40 may contact a side wall of the tire bead seated in first bead seat 12 to restrain axial movement of the bead in the direction of the inboard side.

In some exemplary embodiments, inboard flange 40 may have a height of about 3.5 inches when measured from an edge surface in contact with the outer surface of conical section 33 to the outermost surface away from axial centerline 25.

Outboard flange assembly 50 may be formed of a unitary construction (e.g., via forging or molding), integrating a bead seat section 53 and an outboard flange section 57 to define second bead seat 18, as best shown in FIG. 3. Bead seat section 53 may be formed of a substantially cylindrical body extending substantially parallel to the axial centerline 25 of rim base 20 and having an inner diameter slightly larger than the outer diameter of center section 35 and gutter section 37 of rim base 20, so as to allow axial movement of outboard flange assembly 50 over and relative to the outer surface of rim base 20. Bead seat section 53 may be generally tapered towards the center of rim base 20 to define an inclined outer surface for contacting the bead. In some exemplary embodiments, the degree of inclination in the inclined outer surface is about 5 degrees with respect to the outer surface of center section 35 of rim base 20.

Outboard flange section 57, formed integrally with bead seat section 53, may first extend radially outwardly from bead seat section 53 and then curve radially outwardly towards the outboard side to form a generally convex shape. When a tire is mounted, outboard flange section 57 may contact a side wall of the tire bead seated in second bead seat 18 to restrain axial movement of the bead in the outboard direction.

As best shown in FIG. 3, outboard flange assembly 50 may be disposed radially on the outer surface of center section 35 and gutter section 37 of rim base 20. Outboard flange assembly 50 may have an inner periphery 56 radially adjacent to the outer surface of rim base 20. Inner periphery 56 may define a load transferring surface 59 extending radially and axially outwardly to contact lock ring 60 in an assembled condition.

As mentioned above, a suitable sealing member may be disposed within the gap between the outer surface of rim base 20 and inner periphery 56 so that the gap is sealed against the passage of air therethrough when outboard flange assembly 50 is securely assembled in place.

Lock ring 60 may be an annular split lock ring having a first portion 62 extending radially inward towards axial centerline 25 to be received in lock ring groove 28 of rim base 20. Lock ring 60 may also include a second portion 64 having an angled wedge surface configured to contact load transferring surface 59 of outboard flange assembly 50 when lock ring 60 is seated in lock ring groove 28. Lock ring 60 may also include a seat surface 66 configured to contact the outer surface of rim base 20 in an assembled condition.

By way of example only, the width w of rim assembly 10, as measured between the inner surface of inboard flange 40 and the inner surface of outboard flange section 57 as shown in FIG. 2, may range from about 25 inches to about 30 inches. In one exemplary embodiment, the range may be between about 27.5 inches and about 28.1 inches.

### INDUSTRIAL APPLICABILITY

The disclosed multi-piece rim assembly may be applicable to various types of vehicles designed to perform heavy-duty applications, such as, for example, earthmoving vehicles, cranes, hauling trucks and trailers, and military vehicles. As will be described in more detail herein, various exemplary embodiments of the present disclosure may enhance manufacturing efficiency and part simplification while maintaining substantially the same level of serviceability as that offered by more complex rim structures and without compromising the structural integrity of the rim assembly. With reference to FIGS. 2 and 3, an exemplary method in which a tire can be mounted to and demounted from rim assembly 10 of the present disclosure will be described herein.

To mount a tire (not shown) to rim assembly 10, inboard flange 40 is first mounted axially on rim base 20 from the outboard side, and the tire is axially inserted over rim base 20 until a first tire bead engages with inboard flange 40 and conical section 33 of rim base 20. Outboard flange assembly 50 is then slidably inserted over the outer surface of rim base 20, where tapered bead seat section 53 penetrates into a gap between a second tire bead (not shown) and the outer surface of rim base 20, causing the second tire bead to be seated in second bead seat 18 and contact the outer surface of bead seat section 53 and outboard flange section 57. Outboard flange assembly 50 carrying the second tire bead is then pushed in the axial direction towards the first tire bead, such that first portion 62 of lock ring 60 can be placed in lock ring groove 28 and a suitable sealing member can be placed in sealing groove 29. After arranging lock ring 60 and the sealing member, outboard flange assembly 50 is allowed to move towards the outboard side as a result of the second tire bead's tendency to restore its non-deformed state. This movement towards the outboard side continues until load transferring surface 59 of outboard flange assembly 50 contacts the angled wedge surface of second portion 64 of lock ring 60, whereupon any further movement is restricted and lock ring 60 is secured in lock ring groove 28. Once the tire is inflated, the pressure exerted by the inflated tire causes lock ring 60 to be firmly retained in lock ring groove 28.

To demount a tire from rim assembly 10, the tire is first allowed to be deflated. Once the tire is fully deflated, a suitable bead breaking tool (not shown) can be inserted into a gap between back flange 21 of rim base 20 and detachable inboard flange 40 to unseat the first tire bead from rim base 20 on the inboard side. On the outboard side, outboard flange assembly 50 can be pushed axially towards the first tire bead, whereupon the deflated tire allows deformation of the second tire bead and an axial displacement of outboard flange assembly 50. Displaced outboard flange assembly 50 exposes lock ring 60, and lock ring 60 can be removed from lock ring groove 28. After lock ring 60 is removed, outboard flange assembly 50 can be removed from rim base 20. Subsequently, the tire can be removed from rim base 20.

As described above, forming bead seat section 53 and outboard flange section 57 in a single-piece construction on the outboard side, while inboard flange 40 remains detachable from rim base 20 on the inboard side, can simplify not only the overall rim structure but also the mounting and/or demounting procedure without compromising the structural integrity or serviceability.

It should be noted that the particular distinction made in the description above with respect to the inboard and outboard sides of the disclosed rim structures is merely to facilitate the explanation of certain features of the present disclosure and is not intended to limit certain features uniquely to either the inboard or outboard side. For example, although flange 40 and flange assembly 50 of rim assembly 10 are referred to as inboard flange 40 and outboard flange assembly 50, respectively, it should be understood that flange 40 and flange assembly 50 can also be an outboard flange and inboard flange assembly, respectively.

It will be apparent to those skilled in the art that various modifications and variations can be made to the disclosed multi-piece rim assemblies. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A multi-piece rim assembly for mounting a tire, comprising:
a rim base having a first end and a second end;
a flange detachably mountable to the first end of the rim base, the flange and the rim base cooperatively defining a first bead seat for receiving a first bead of the tire;
a flange assembly detachably mountable to the second end of the rim base and defining a second bead seat for receiving a second bead of the tire, the flange assembly being formed of a unitary construction comprising:
a bead seat section having an outer surface for contacting a bottom edge of the second bead of the tire; and
a flange section extending substantially radially outwardly from the bead seat section to contact a side wall of the second bead of the tire; and
a lock ring configured to secure the flange assembly to the rim base.

2. The multi-piece rim assembly of claim 1, wherein an outer diameter of the rim base is greater than about 25 inches.

3. The multi-piece rim assembly of claim 2, wherein the outer diameter of the rim base is about 33 inches.

4. The multi-piece rim assembly of claim 1, wherein the first end is disposed on an inboard side of the rim base, and the second end is disposed on an outboard side of the rim base.

5. The multi-piece rim assembly of claim 1, wherein the rim base comprises a back flange extending radially outwardly from the first end to detachably engage with the flange.

6. The multi-piece rim assembly of claim 5, wherein the back flange includes a first locking member and the flange includes a second locking member, wherein the first locking member and the second locking member are configured to engage one another to substantially prevent relative rotation with respect to one another.

7. The multi-piece rim assembly of claim 1, wherein the rim base comprises:
a substantially cylindrical center section have a first end and a second end;
a conical section joined to the first end of the center section and forming an inclined outer surface that defines a portion of the first bead seat; and
a gutter section joined to the second end of the center section and defining a lock ring groove for receiving the lock ring.

8. A multi-piece rim assembly for mounting a tire, comprising:
a rim base having a first end and a second end, the rim base having an outer diameter greater than about 25 inches;
a flange detachably mountable to the first end of the rim base to restrain a first bead of the tire;
a flange assembly detachably mountable to the second end of the rim base to restrain a second bead of the tire, the flange assembly comprising:
a bead seat section having an outer surface for contacting a bottom edge of the second bead of the tire; and
a flange section integrally formed with and extending radially outwardly from the bead seat section to contact a side wall of the second bead of the tire; and
a lock ring configured to secure the flange assembly to the rim base.

9. The multi-piece rim assembly of claim 8, wherein the outer diameter of the rim base is about 33 inches.

10. The multi-piece rim assembly of claim 8, wherein the first end is disposed on an inboard side of the rim base, and the second end is disposed on an outboard side of the rim base.

11. The multi-piece rim assembly of claim 8, wherein the rim base comprises a back flange extending radially outwardly from the first end to detachably engage with the flange.

12. The multi-piece rim assembly of claim 11, wherein the back flange includes a first locking member and the flange includes a second locking member, and wherein the first locking member and the second locking member are configured to engage one another to substantially prevent relative rotation with respect to one another.

13. The multi-piece rim assembly of claim 8, wherein the bead seat section and the flange section are formed of a unitary construction.

14. The multi-piece rim assembly of claim 8, wherein the rim base comprises:
a substantially cylindrical center section have a first end and a second end;
a conical section joined to the first end of the center section and forming an inclined outer surface that defines a portion of a first bead seat for restraining the first bead of the tire; and
a gutter section joined to the second end of the center section and defining a lock ring groove for receiving the lock ring.

15. A method of demounting a tire from a multi-piece rim assembly, the rim assembly comprising a rim base, a flange detachably mountable to a first end of the rim base, a flange assembly detachably mountable to a second end of the rim base, the method comprising:
inserting a bead breaking tool into a gap between the first end of the rim base and the flange to unseat a first tire bead from the rim base;
displacing the flange assembly axially from the second end towards the first tire bead, wherein the flange assembly is formed of a unitary construction comprising a bead seat section for contacting a bottom edge of a second bead of the tire and a flange section for contacting a side wall of the second bead of the tire;
removing a lock ring while the flange assembly is being displaced axially towards the first tire bead;
removing the flange assembly in the direction of the second end; and
removing the tire from the rim base in the direction of the second end.

16. The method of claim 15, wherein an outer diameter of the rim base is greater than about 25 inches.

17. The method of claim 16, wherein the outer diameter of the rim base is about 33 inches.

18. The method of claim 15, wherein the first end of the rim base is disposed on an inboard side of the rim base, and the second end of the rim base is disposed on an outboard side of the rim base.

19. The method of claim 15, wherein the rim base comprises a back flange extending radially outwardly from the first end to detachably engage with the flange, and the method further comprises engaging a first locking member of the back flange with a second locking member of the flange to substantially prevent relative rotation with respect to one another.

20. The method of claim 19, wherein the back flange defines a groove for receiving the first locking member on a surface that faces the flange.
